(19) United States
(12) Patent Application Publication
(10) Pub. No.: US 2017/0164789 A1
(43) Pub. Date: Jun. 15, 2017

(54) EMERGENCY SHOWER AND/OR EYEWASH STATION WITH INTEGRATED HEATER

(71) Applicant: Haws Corporation, Sparks, NV (US)

(72) Inventors: Michael Joyer, Reno, NV (US); Daniel Small, Reno, NV (US)

(21) Appl. No.: 15/374,200

(22) Filed: Dec. 9, 2016

Related U.S. Application Data
(60) Provisional application No. 62/266,191, filed on Dec. 11, 2015.

(51) Int. Cl. A47K 3/28; A61H 33/00; G05D 23/13

(52) U.S. Cl. CPC A47K 3/286; G05D 23/1393; A61H 33/005; A61H 33/00

(57) ABSTRACT

An emergency shower includes a column having upper and lower inlets, outer, intermediate, and inner pipes defining outer, intermediate, and inner conduits, and one or more heating coils positioned within one or more of the conduits. An instantaneous water heater can be integrated into the column of the emergency shower. The emergency shower can include a shower head and an eyewash assembly for cleaning a person after the person encounters toxic materials.

### BACKGROUND

Technical Field

The present disclosure relates generally to integrated heaters, and more particularly to integrated instantaneous water heaters for use in emergency showers.

Description of the Related Art

Various emergency showers are commercially available for use in laboratory, industrial, and other settings in which toxic materials are used or encountered. Some emergency shower systems are designed to meet one or more ANSI standards, to integrate with existing infrastructure, to include eyewash systems, and/or to provide tempered water for rapid decontamination and emergency washing.

### BRIEF SUMMARY

An emergency shower can be summarized as including a column, a water inlet coupled to the column, a water heater positioned inside the column, the water heater in fluid communication with the water inlet, and a shower head in fluid communication with the water heater.

The emergency shower may further comprise an eyewash assembly in fluid communication with the water heater. The column may include a first pipe and a second pipe arranged concentrically with the first pipe, the first pipe defining an outer surface of a first conduit, and the second pipe defining an outer surface of a second conduit arranged radially outward of the first conduit. The first conduit may be in fluid communication with the second conduit. The second conduit may have an annular profile that extends circumferentially around the first conduit. The column may include a third pipe arranged concentrically with the first pipe and the second pipe and the third pipe may define an outer surface of a third conduit arranged radially outward of the first conduit and the second conduit. The second conduit may be in fluid communication with the third conduit. The third conduit may have an annular profile that extends circumferentially around the first conduit and the second conduit. The water inlet may be in fluid communication with the third conduit.

The emergency shower may further comprise an eyewash assembly in fluid communication with the water heater. The eyewash assembly may include an eyewash pipe that extends through the third pipe, through the third conduit, through the second pipe, through the second conduit, and through the first pipe.

An emergency shower can also be summarized as including a column including a top end, a bottom end, an outer pipe, an intermediate pipe positioned within the outer pipe, an inner pipe positioned within the intermediate pipe, an annular outer conduit defined between the intermediate pipe and the outer pipe, an annular intermediate conduit defined between the inner pipe and the intermediate pipe, and an inner conduit defined within the inner pipe, the inner conduit in fluid communication with the intermediate conduit at one end of the inner pipe, and the intermediate conduit in fluid communication with the outer conduit at an opposing end of the intermediate pipe, a lower inlet in fluid communication with the outer conduit and physically coupled to the bottom end of the column, an upper inlet in fluid communication with the outer conduit and physically coupled to the top end of the column, a heating coil positioned within the intermediate conduit, and a shower head in fluid communication with the inner conduit such that a flow path exists from the lower inlet, through the outer conduit to the intermediate conduit, through the intermediate conduit to the inner conduit, and through the inner conduit to the shower head.

A method of using an emergency shower can be summarized as including: providing a flow of water to an inlet coupled to a column, the inlet in fluid communication with a water heater positioned inside the column and with a shower head coupled to a top end portion of the column; and causing the water to flow into the emergency shower through the inlet, through the water heater, and out of the emergency shower through the shower head by actuating a lever coupled to the emergency shower.

### BRIEF DESCRIPTION OF THE SEVERAL VIEWS OF THE DRAWINGS

FIG. 1 is a perspective view of an emergency shower and eyewash station, according to at least one illustrated embodiment.

FIG. 2 is another perspective view of the emergency shower and eyewash station of FIG. 1, according to at least one illustrated embodiment.

FIG. 3 is a detailed view of some components of the emergency shower and eyewash station of FIG. 1, according to at least one illustrated embodiment.

FIG. 4 is a cross-sectional view of some components of the emergency shower and eyewash station of FIG. 1, according to at least one illustrated embodiment.

FIG. 5 is a detailed view of some components of the emergency shower and eyewash station of FIG. 1, according to at least one illustrated embodiment.

FIG. 6 is another detailed view of some components of the emergency shower and eyewash station of FIG. 1, according to at least one illustrated embodiment.

FIG. 7 is another detailed view of some components of the emergency shower and eyewash station of FIG. 1, according to at least one illustrated embodiment.

FIG. 8 is another detailed view of some components of the emergency shower and eyewash station of FIG. 1, according to at least one illustrated embodiment.

FIG. 9 is a detailed view of some components of the emergency shower and eyewash station of FIG. 1 in a partially disassembled state, according to at least one illustrated embodiment.

FIG. 10 is another detailed view of some components of the emergency shower and eyewash station of FIG. 1 in a partially disassembled state, according to at least one illustrated embodiment.

FIG. 11 is another detailed view of some components of the emergency shower and eyewash station of FIG. 1 in a partially disassembled state, according to at least one illustrated embodiment.

FIG. 12 is another detailed view of some components of the emergency shower and eyewash station of FIG. 1 in a partially disassembled state, according to at least one illustrated embodiment.

FIG. 13 is a cross-sectional and detailed view of some components of the emergency shower and eyewash station of FIG. 1, according to at least one illustrated embodiment.

FIG. 14 is a detailed view of some components of the emergency shower and eyewash station of FIG. 1, according to at least one illustrated embodiment.

FIG. 15 is another detailed view of some components of the emergency shower and eyewash station of FIG. 1, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

As used herein, the terms “up,” “down,” “top,” “bottom,” “upper,” “lower,” and other similar terms of relative elevation generally carry their ordinary meanings, such that, for example, gravity pulls from top to bottom.

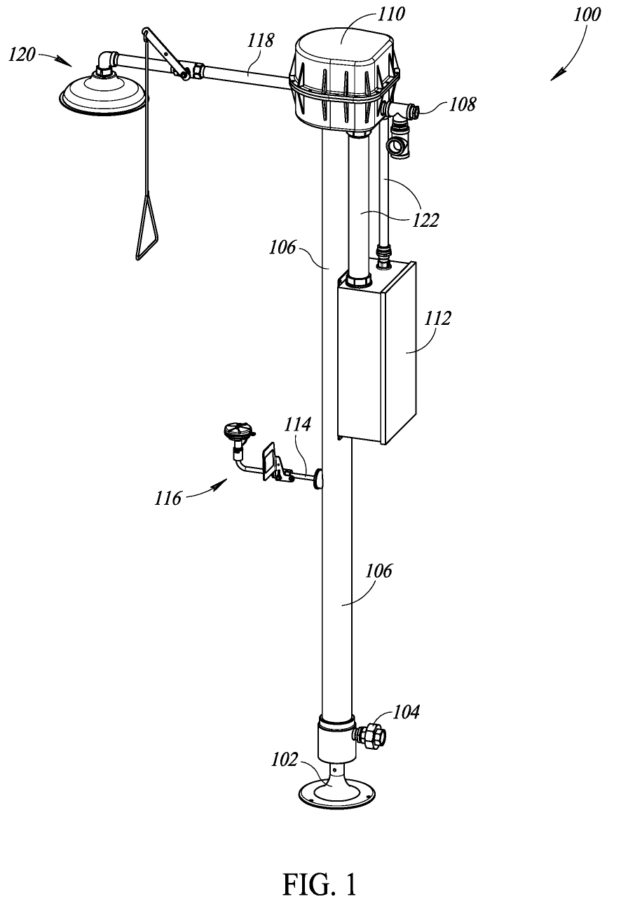

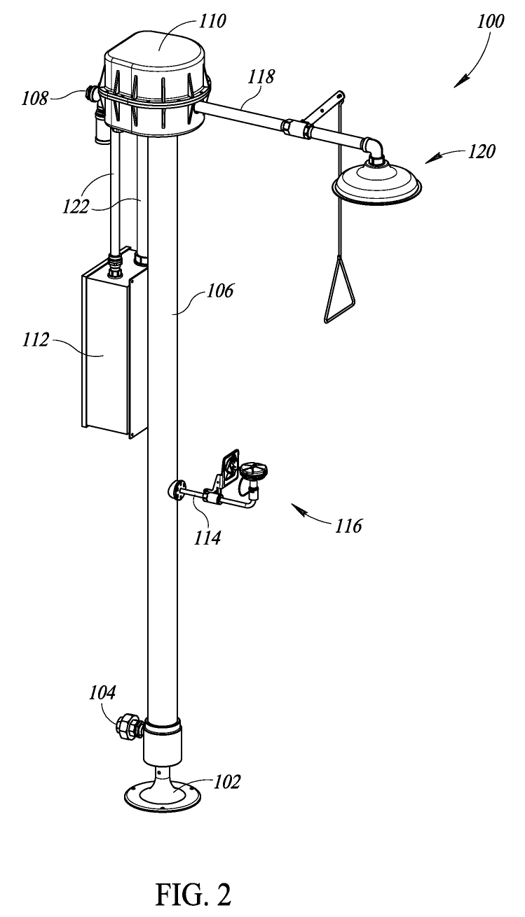

FIGS. 1 and 2 show two different perspective views of an emergency shower 100. The emergency shower 100 includes a pedestal 102, a lower inlet 104, a column 106, an upper inlet 108, a cover 110, control line and utility conduits 122 coupled to a control panel 112, an eyewash pipe 114 fluidly coupled to an eyewash assembly 116, and a horizontal shower pipe 118 fluidly coupled to a shower assembly 120. The emergency shower 100 can be used in laboratory, industrial, or other settings in which toxic materials might be encountered, and can be used to rapidly clean or decontaminate a person working in such an environment.

As described in greater detail below, the emergency shower 100 includes an integrated instantaneous water heater so that it can be installed in any setting with access to a source of running water, such as water having a temperature between 32 and 100 degrees Fahrenheit, a line pressure between 30 and 90 psi, and a flow rate of at least 25 gallons per minute. The emergency shower 100 can be fluidly coupled to the source of running water such that it is immediately capable of producing a continuous flow of tempered water upon flushing an initial quantity (e.g., the quantity of water sitting in the emergency shower 100 prior to use) of un-tempered water out of the emergency shower 100.

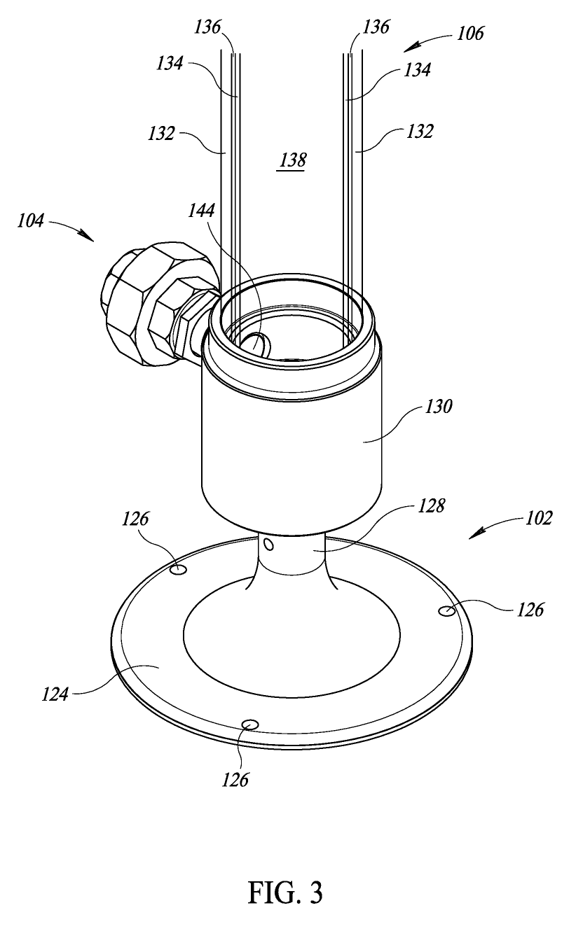

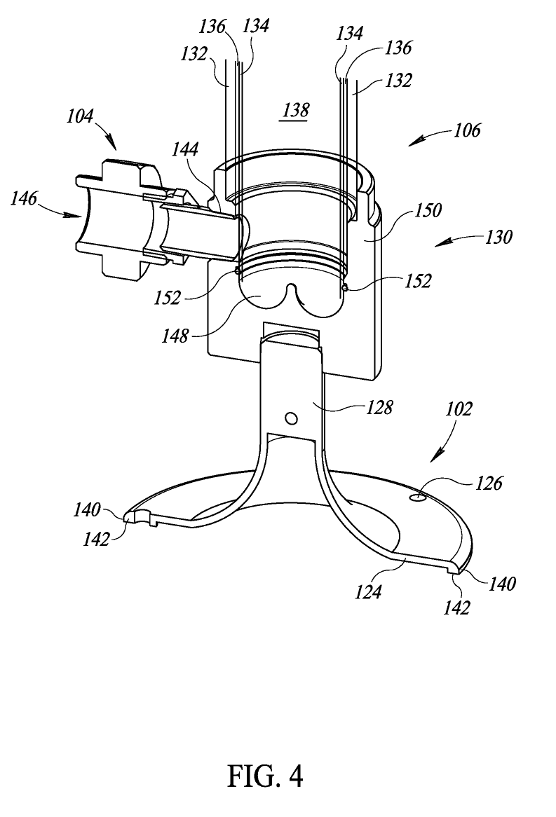

FIGS. 3 and 4 show a detailed view and a cross-sectional view, respectively, of the pedestal 102, the lower inlet 104, and a bottom portion of the column 106. The pedestal 102 includes a bottom flange 124 having a peripheral bottom ridge 140 with a flat bottom surface 142 and a plurality of (e.g., three) equidistantly spaced through-holes 126. The flange 124 can be securely and fixedly coupled to a floor or ground surface, such as by placing its flat bottom surface 142 on the floor or ground surface and fastening the flange 124 to the floor or ground surface using bolts, screws, nails, or other fasteners extending through the holes 126. In other embodiments, the pedestal 102 can be secured to the floor or ground surface in any suitable way, such as by using any suitable mechanical fastener(s) and/or adhesive(s). The pedestal 102 can taper upwards from the bottom flange 124 toward a neck 128 of the pedestal 102. The pedestal 102 and its neck 128 can support the rest of the emergency shower 100 such that the emergency shower 100, and its column 106 in particular, stands vertically with respect to the floor or ground surface.

The column 106 includes a bottom end cap 130, a hollow outer casing, sleeve, tube, or pipe, 132 and a hollow intermediate casing, sleeve, tube, or pipe 134 positioned concentrically within the outer pipe 132. The intermediate pipe 134 and the outer pipe 132 are transparent in FIG. 3 so features of the emergency shower 100 are more clearly illustrated. The bottom end cap 130 is mounted on top of the neck 128 of the pedestal 102, and the intermediate pipe 134 and the outer pipe 132 are mounted within and on the bottom end cap 130. Together, the intermediate pipe 134 and the outer pipe 132 form a vertical support post for other components of the emergency shower 100, as discussed further below. An outer open space, chamber, or conduit, 136 has an annular shape and is defined between the intermediate pipe 134 and the outer pipe 132, and an inner open space or chamber 138 is defined within the intermediate pipe 134.

The bottom end cap 130 includes a bottom portion 148, a hollow cylindrical side wall 150, and a through-hole or opening 144 formed in the side wall 150. As shown in FIG. 4, the bottom inlet 104 includes an internal conduit 146 that is fluidly coupled, through the opening 144, to the outer conduit 136. A bottom end of the intermediate pipe 134 abuts the bottom portion 148 of the bottom end cap 130 so that the inner chamber 138 terminates at the bottom end cap 130. An internal surface of the side wall 150 includes a groove 152 into which a seal such as a sealing o-ring can be positioned and seated to separate and seal the outer conduit 136 from the inner chamber 138, so that the outer conduit 136 also terminates at the bottom end cap 130.

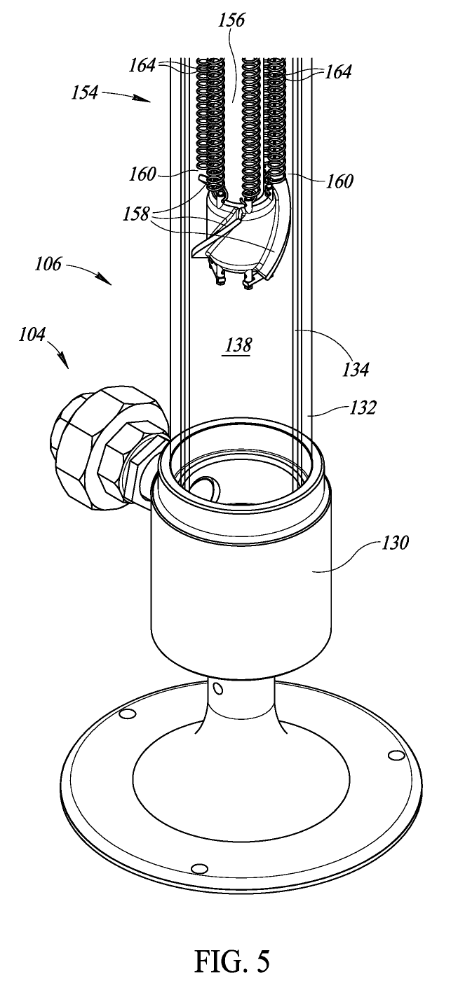

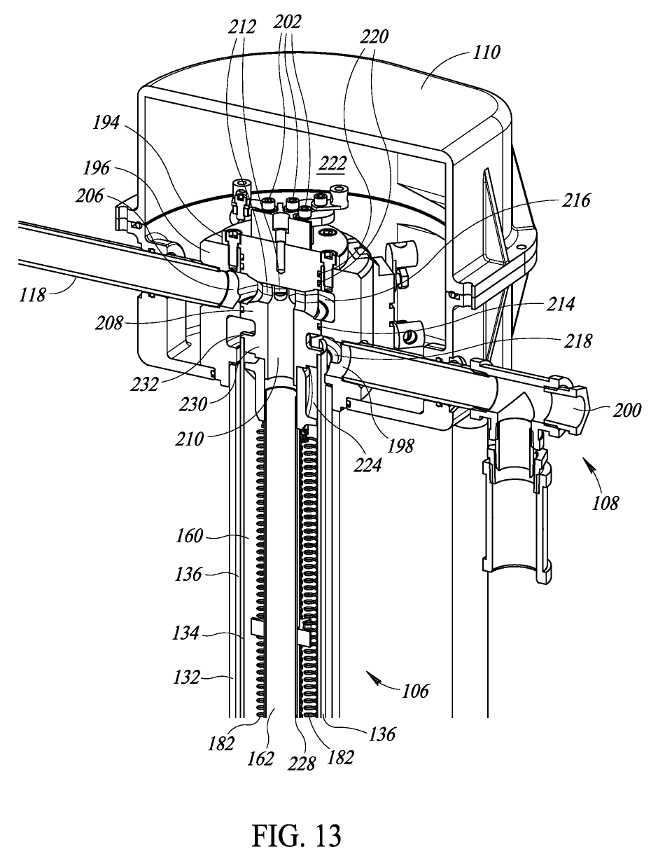

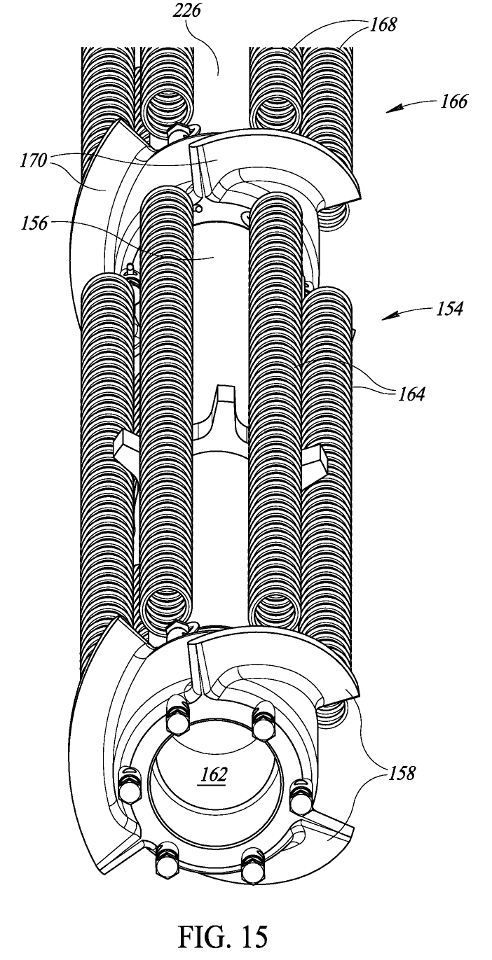

FIG. 5 illustrates additional portions of the column 106, with the intermediate pipe 134 and outer pipe 132 still transparent so features of the emergency shower 100 are more clearly illustrated. In particular, FIG. 5 illustrates that a bottom heater 154 is positioned within the intermediate pipe 134. FIG. 5 illustrates that the bottom heater 154 includes a hollow inner pipe 156 that separates an inner conduit 162 (see FIGS. 13 and 15) within the inner pipe 156 from an intermediate conduit 160 that has an annular shape and is defined between the inner pipe 156 and the intermediate pipe 134. The column 106 therefore includes, from a central longitudinal axis of the column 106 moving outwards, the inner conduit 162, the inner pipe 156, the intermediate conduit 160, the intermediate pipe 134, the outer conduit 136, and the outer pipe 132. Each of these components can be co-axial with the others.

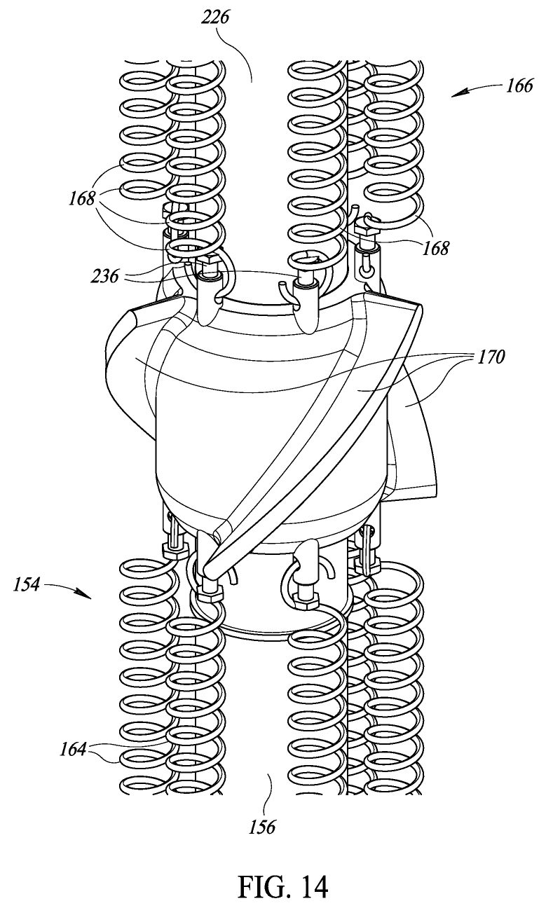

The inner conduit 162 and the intermediate conduit 160 are both in fluid communication with the inner chamber 138 positioned below the bottom heater 154, such that a fluid can flow from the inner conduit 162 to the intermediate conduit 160, or from the intermediate conduit 160 to the inner conduit 162, through the inner chamber 138. FIG. 5 further illustrates that the bottom heater 154 includes a plurality of helical fins 158 coupled to a bottom end of the inner pipe 156, and a plurality of (e.g., six) heating elements such as heating coils 164 spaced equidistantly around the inner pipe 156. In some embodiments, the bottom heater 154 can be positioned so that its helical fins 158 are positioned within the hollow cylindrical side wall 150. Additional details of the bottom heater 154 are illustrated in FIGS. 14 and 15.

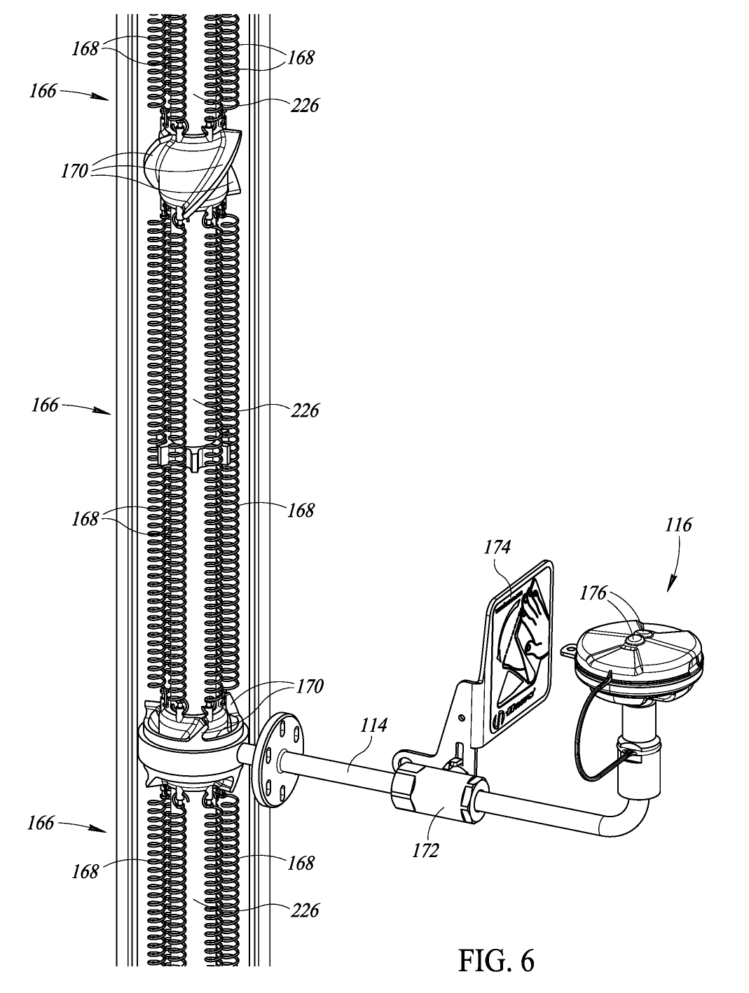

FIG. 6 illustrates that a plurality of intermediate heaters 166 are also positioned within the intermediate pipe 134. The intermediate heaters 166 have features matching those of the bottom heater 154, and are positioned above the bottom heater 154 within the intermediate pipe 134. A bottom end of a bottom-most one of the intermediate heaters 166 is coupled to a top end of the bottom heater 154 such that the inner conduit 162 extends through both the bottom heater 154 and the intermediate heaters 166 and such that separation between the inner conduit 162 and the intermediate conduit 160 is maintained along the lengths of the bottom heater 154 and the intermediate heaters 166. The intermediate heaters 166 each include helical fins 170 at a bottom end thereof, an inner pipe 226, and a plurality of (e.g., six) heating coils 168, which can be thermally and/or electrically coupled with the heating coils 164 of the bottom heater 154, such as through the helical fins 170.

FIG. 6 also illustrates the eyewash assembly 116, which includes an eyewash valve 172 positioned in the eyewash pipe 114 and an eyewash lever 174 coupled to the eyewash valve 172 to actuate the eyewash valve 172 to move between an open configuration and a closed configuration. The eyewash assembly 116 also includes one or more eyewash nozzles 176, through which water can be discharged to wash a user's eyes when the lever 174 is used to actuate the valve 172 to move to the open configuration so that water can flow from the eyewash pipe 114, through the eyewash valve 172, and out of the eyewash nozzles 176.

FIG. 6 also illustrates that the eyewash pipe 114 extends through the outer pipe 132, through the outer conduit 136, through the intermediate pipe 134, through the intermediate conduit 160, and through one of the heaters 166, including the helical fins 170 and the pipe 226, to fluidly couple the inner conduit 162 to the eyewash valve 172, and so that the internal conduit within the eyewash pipe 114 upstream of the eyewash valve 172 can be wet, or filled with water, in advance of the lever 174 being used to actuate the valve 172 to the open configuration.

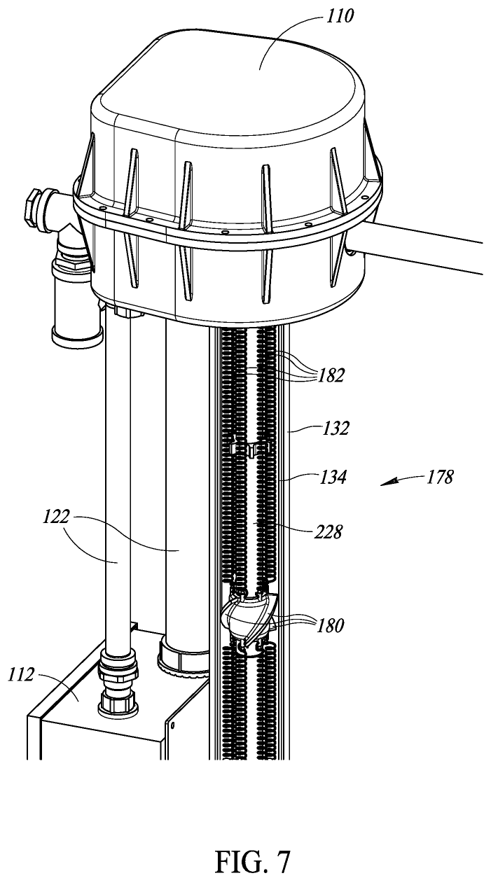

FIG. 7 illustrates a top end portion of the column 106, with the intermediate pipe 134 and the outer pipe 132 still transparent so features of the emergency shower 100 are more clearly illustrated. FIG. 7 illustrates that a top heater 178 is also positioned within the intermediate pipe 134. The top heater 178 has features matching those of the bottom and intermediate heaters 154, 166, and is positioned above the intermediate heaters 166 within the intermediate pipe 134. A bottom end of the top heater 178 is coupled to a top end of a top-most one of the intermediate heaters 166 such that the inner conduit 162 extends through each of the bottom heater 154, the intermediate heaters 166, and the top heater 178, and such that separation between the inner conduit 162 and the intermediate conduit 160 is maintained across the lengths of the heaters. The top heater 178 includes helical fins 180 at a bottom end thereof, an inner pipe 228, and a plurality of (e.g., six) heating coils 182, which can be thermally and/or electrically coupled with the heating coils 168 of the intermediate heaters 166, such as through the helical fins 180.

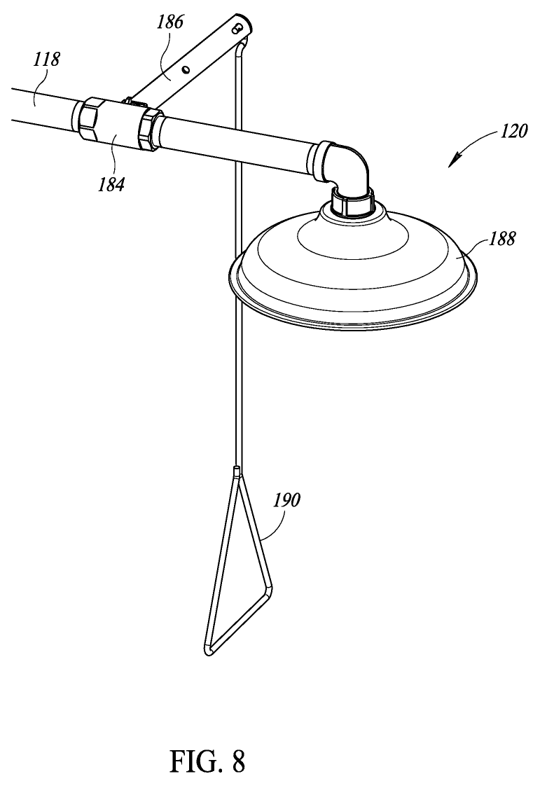

FIG. 8 illustrates that the shower assembly 120 includes a shower valve 184 positioned in the shower pipe 118, as well as a shower lever 186 and a shower handle 190 coupled to the shower valve 184 to actuate the shower valve 184 to move between an open configuration and a closed configuration. The shower assembly 120 also includes a shower head 188, through which water can be discharged to wash a user when the shower handle 190 is pulled to actuate the lever 186 to move the valve 184 to the open configuration so that water can flow from the shower pipe 118, through the shower valve 184, and out of the shower head 188. The internal conduit within the shower pipe 118 upstream of the shower valve 184 can be wet, or filled with water, in advance of the lever 186 being used to actuate the valve 184 to the open configuration.

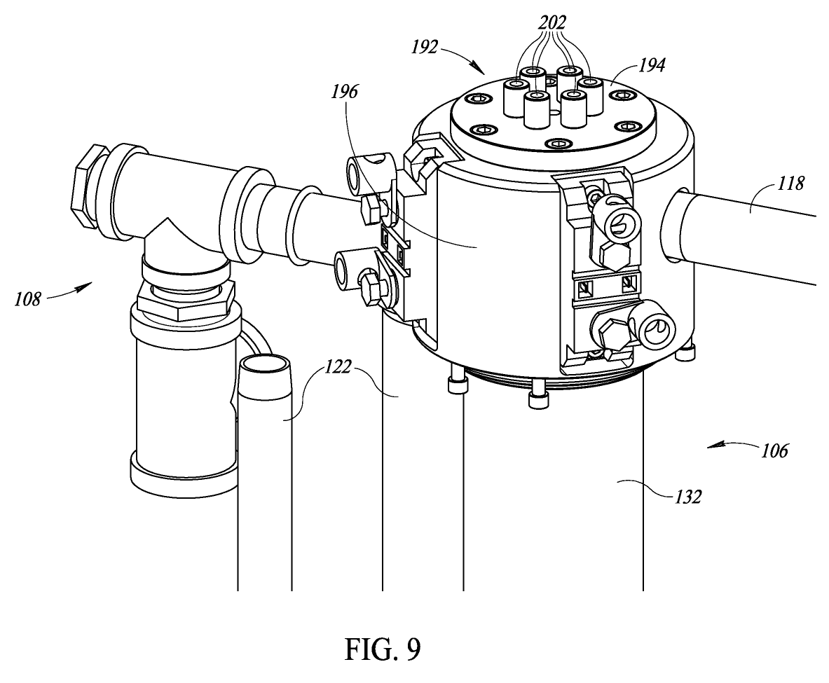

FIG. 9 illustrates a top end portion of the column 106, with the emergency shower 100 partially disassembled so features of the emergency shower 100 are more clearly illustrated. In particular, FIG. 9 illustrates the top end portion of the column 106 with the cover 110 removed. FIG. 9 illustrates that the column 106 includes a top end cap 192, which includes a top plate 194, a hollow cylindrical side wall 196, an inlet through-hole or opening 198 (see FIG. 13) formed in the side wall 196, and out outlet through-hole or opening 206 (see FIG. 13). The upper inlet 108 has features matching those of the lower inlet 104, including an internal conduit 200 (see FIG. 13) that is fluidly coupled, through the opening 198, to the outer conduit 136.

FIG. 9 also illustrates that a plurality of (e.g., six) leads 202, which are thermally and/or electrically coupled to the heating coils 182, extend, in a watertight fashion, through the top plate 194 of the top cap 192. The leads 202 can be further coupled, such as by wires extending through one of the control line and utility conduits 122, to the control panel 112, which can include an on/off switch and a control system for the emergency shower 100, as described further below.

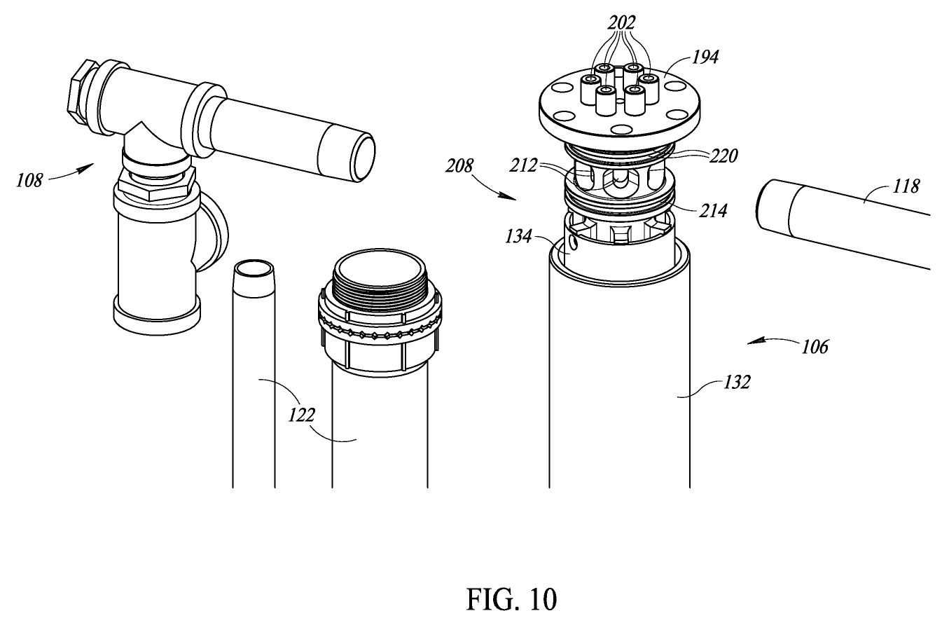

FIG. 10 illustrates the top end portion of the column 106 of FIG. 9, with the emergency shower 100 further disassembled so features of the emergency shower 100 are more clearly illustrated. In particular, FIG. 10 illustrates the top end portion of the column 106 with the cylindrical side wall 196 of the top end cap 192 removed. FIG. 10 illustrates that the column 106 includes an outlet manifold 208 positioned within the top end cap 192. The outlet manifold 208 includes a vertical central internal conduit 210 (see FIG. 13) that extends upwardly through the manifold 208 and splits into a plurality of horizontal conduits 212 extending radially outward from the central internal conduit 210.

The outlet manifold 208 includes a lower peripheral groove 214 that extends circumferentially around the manifold 208, within which a sealing element such as a sealing o-ring can be seated to separate an upper chamber 216 (see FIG. 13) of the top cap 192 from a lower chamber 218 (see FIG. 13) of the top cap 192. The outlet manifold 208 also includes one or more upper peripheral grooves 220 that extend circumferentially around the manifold 208, within which respective sealing elements such as sealing o-rings can be seated to separate the upper chamber 216 (see FIG. 13) of the top cap 192 from an external environment of the top cap 192, such as an open space 222 within the cover 110.

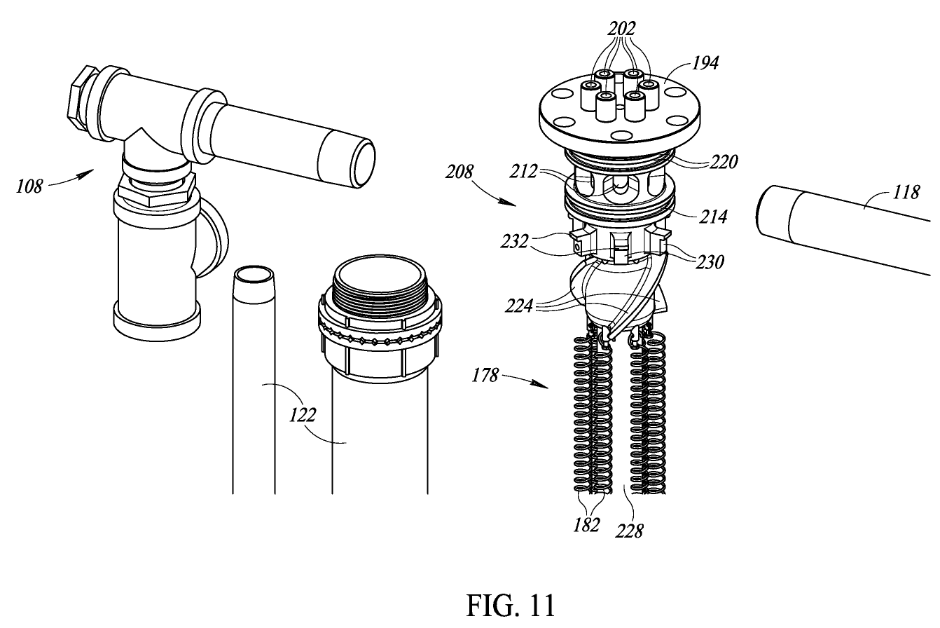

FIG. 11 illustrates the top end portion of the column 106 of FIG. 9, with the emergency shower 100 further disassembled so features of the emergency shower 100 are more clearly illustrated. In particular, FIG. 11 illustrates the top end portion of the column 106 with the outer pipe 132 and the intermediate pipe 134 removed. FIG. 11 illustrates that the top heater 178 includes a plurality of helical fins 224 coupled to a top end of the inner pipe 228. FIG. 11 further illustrates that the manifold 208 includes a plurality of protrusions or fins 230 extending radially outward, and an upper lip 232 protruding further radially outward from a top end of each of the fins 230. When the emergency shower 100 is assembled, the intermediate pipe 134 can be seated or abutted against the outer surfaces of the fins 230 and the undersides of the lips 232 such that the intermediate conduit 160 extends upwards between the fins 230 into the lower chamber 218.

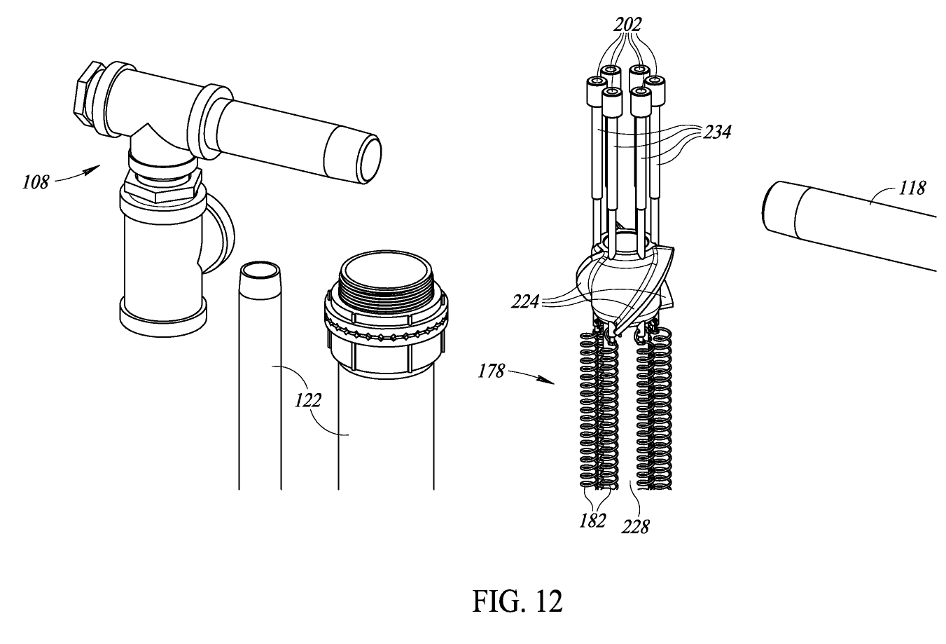

FIG. 12 illustrates the top end portion of the column 106 of FIG. 9, with the emergency shower 100 further disassembled so features of the emergency shower 100 are more clearly illustrated. In particular, FIG. 12 illustrates the top end portion of the column 106 with the manifold 208 and the top plate 194 removed. FIG. 12 illustrates that the leads 202 are thermally and/or electrically coupled to the heating coils 182 via cables, wires, or pipes 234, which extend from the leads 202, through the helical fins 224, to the heating coils 182.

FIG. 13 illustrates a cross-sectional view of a top end portion of the column 106, including various conduits and chambers located at the top end portion of the column 106. FIG. 13 also illustrates that the top plate 194 can be integrally formed with the outlet manifold 208. FIG. 14 illustrates additional details of the connection between the heating coils 164 of the bottom heater 154 and the heating coils 168 of a bottom-most one of the intermediate heaters 166. For example, the heating coils 164 are thermally and/or electrically coupled to the heating coils 168 via cables, wires, or pipes 236, which extend through the helical fins 170. FIG. 15 illustrates the bottom heater 154 and the bottom-most one of the intermediate heaters 166 from underneath, and shows an entrance to the inner conduit 162 at a bottom end of the bottom heater 154.

The emergency shower 100 can be sold and shipped to an installation location as a single, assembled unit. Once received at the installation location, the emergency shower 100 can be fluidly coupled to a source of water, such as a source of cold water, and electrically coupled to a source of electric power. As examples, a source of water can be fluidly coupled to the lower inlet 104 and the upper inlet 108 can be capped, or the source of water can be fluidly coupled to the upper inlet 108 and the lower inlet 104 can be capped, or the source of water can be fluidly coupled to both the lower inlet 104 and the upper inlet 108, or a first source of water can be coupled to the lower inlet 104 and a second source of water can be coupled to the upper inlet 108. Further, a source of electric power can be electrically coupled to the control panel 112. The emergency shower 100 can then be ready for use, without being coupled to a separate water heater.

When the emergency shower 100 is in use, electricity is drawn from the source of electric power, through the control panel, and to the heating coils 182, 168, and 164, where it is used to heat the heating coils and thereby to heat water flowing through the emergency shower 100. Water flows from the source of water into the emergency shower through the lower inlet 104, the upper inlet 108, or both. Water flowing in through the lower inlet 104 flows upwards through the column 106 through the outer conduit 136 until it reaches the lower chamber 218 within the top cap 192. Water flowing in through the upper inlet 108 flows directly into the lower chamber 218. The water then flows from the lower chamber 218, over the top of the intermediate pipe 134, and down between the fins 230 into the intermediate conduit 160. The water then flows down through the intermediate conduit 160 until it reaches the inner chamber 138 at the bottom of the column 106.

As the water flows down through the conduit 160, it flows past the heating coils 182, 168, and 164, and heat energy is transferred from the heating coils 182, 168, and 164 to the water, heating the water. The water also flows past the helical fins 224, 180, 170, and 158, which cause the water to rotate and mix as it moves down through the conduit 160, to improve the consistency of the temperature of the water. Once the water reaches the inner chamber 138 at the bottom of the column 106 below the bottom heater 154, the water flows around the bottom end of the bottom heater 154 and upward through the inner conduit 162 (see FIG. 15) extending through the inner pipe 156 of the bottom heater 154, through the inner pipes 226 of the intermediate heaters 166, and through the inner pipe 228 of the top heater 178, into the vertical central internal conduit 210 within the manifold 208.

Once in the manifold 208, the water is distributed radially outward through the plurality of horizontal conduits 212 into the upper chamber 216 of the top cap 192. From the upper chamber 216 of the top cap 192, the water can flow out of the top cap 192 through the opening 206 into the shower pipe 118. When the shower valve 184 is open, the water can flow out of the shower pipe 118 and through the shower head 188.

A method of operation for the emergency shower 100 includes receiving a signal that use of the emergency shower 100, such as use of the shower assembly 120 or the eyewash assembly 116, is desired by a user. The user can provide this signal by actuating one or both of the levers 174, 186. The method further includes opening the respective valve(s) 172, 184 to allow water to flow out of the emergency shower 100 for use by the user. The method further includes, upon receipt of the signal, turning on the heating coils of the emergency shower 100 to begin heating the water flowing through the emergency shower 100. The method further includes measuring a temperature of the heated water, such as by using a thermometer, thermistor, or other temperature sensor positioned within the upper chamber 216 of the top cap 192, positioned within the eyewash pipe 114, and/or positioned within the inner chamber 138 to monitor the temperature of the water leaving the emergency shower 100.

The method further includes using the measured temperature to control operation of the heating coils of the emergency shower 100 to maintain the temperature of the water leaving the emergency shower 100 at a desired temperature. For example, the emergency shower 100 includes an electronic control system, such as within the control panel 112 and including a microcontroller, which can have a baseline target temperature stored in memory, which can receive a signal indicating the measured temperature, and which can control an amount of electrical power supplied to the heating coils of the emergency shower 100 based on a comparison of the measured temperature with the baseline target temperature. For example, if the measured temperature is lower than the target temperature, then the control system can increase the electric power provided to the heating coils, whereas if the measured temperature is higher than the target temperature, then the control system can decrease the electric power provided to the heating coils. The baseline target temperature can be any desired temperature, with 85 degrees Fahrenheit being one example.

The emergency shower 100 can draw and consume about 150 kW of electric power, at about 480 V or about 600 V. The emergency shower 100 can heat water flow at about 25 gallons per minute by about 45 degrees Fahrenheit, such as from 40 degrees Fahrenheit to about 85 degrees Fahrenheit. The emergency shower 100 can be insulated so that it can be used in extremely cold environments, such as in Canadian oil fields or in Antarctica. For example, the emergency shower 100 can be installed in a frozen environment or an environment below 32 degrees Fahrenheit, and the source of water for the emergency shower 100 can be a pipeline below the frost line. The entire emergency shower 100 can be insulated to a degree sufficient to ensure that the rate at which heat can be transferred from the source of water to the emergency shower is greater than the rate at which heat dissipates from the emergency shower 100 to the surrounding environment.

Thus, no additional heating elements, and no heat tracing, is needed to prevent the emergency shower 100 or any components thereof from freezing. In some embodiments, if a signal provided by a temperature sensor incorporated into the emergency shower, such as a thermometer or a thermistor, indicates that an internal temperature of the emergency shower 100 has fallen below a first threshold value (e.g., 35 or 40 degrees Fahrenheit), then one or more of the heaters 178, 166, and 154 can be turned on until the internal temperature rises to a second threshold value (e.g., 40 or 45 degrees Fahrenheit). In some embodiments, if a signal provided by a temperature sensor monitoring an environmental temperature around the emergency shower 100 indicates that the environmental temperature has fallen below a threshold value, then one or more of the heaters 178, 166, and 154 can be pulsed on and off, at a frequency and for a duration that can vary with the measured environmental temperature. The emergency shower 100 can conform to one or more industry standards for emergency showers, such as ANSI/ISEA Z358.1 and/or UL 499.

The emergency shower 100 is integrated with an instantaneous water heater including the heaters 178, 166, and 154. While the emergency shower 100 includes five such heaters, any number of heaters can be used, such as a single one, two, three, four, five, six, or more heaters positioned within the intermediate pipe 134. Further, while the emergency shower 100 includes the heating coils 164, 168, and 182 positioned between the inner pipes 156, 226, and 228 and the intermediate pipe 134, the heating coils 164, 168, and 182 can take other forms and be located in different positions within the flow path of the water through the emergency shower 100. Further still, while the emergency shower 100 is described as being used with water, other fluids can be used and can flow through the same conduits and chambers as described herein for water.

U.S. Provisional Patent Application No. 62/266,191, filed Dec. 11, 2015, to which this application claims priority, is hereby incorporated by reference in its entirety. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An emergency shower comprising:
a column;
a water inlet coupled to the column;
a water heater positioned inside the column, the water heater in fluid communication with the water inlet; and
a shower head in fluid communication with the water heater.

2. The emergency shower of claim 1, further comprising an eyewash assembly in fluid communication with the water heater.

3. The emergency shower of claim 1 wherein the column includes a first pipe and a second pipe arranged concentrically with the first pipe, the first pipe defines an outer surface of a first conduit, and the second pipe defines an outer surface of a second conduit arranged radially outward of the first conduit.

4. The emergency shower of claim 3 wherein the first conduit is in fluid communication with the second conduit.

5. The emergency shower of claim 3 wherein the second conduit has an annular profile that extends circumferentially around the first conduit.

6. The emergency shower of claim 3 wherein the column includes a third pipe arranged concentrically with the first pipe and the second pipe and the third pipe defines an outer surface of a third conduit arranged radially outward of the first conduit and the second conduit.

7. The emergency shower of claim 6 wherein the second conduit is in fluid communication with the third conduit.

8. The emergency shower of claim 6 wherein the third conduit has an annular profile that extends circumferentially around the first conduit and the second conduit.

9. The emergency shower of claim 6 wherein the water inlet is in fluid communication with the third conduit.

10. The emergency shower of claim 6, further comprising an eyewash assembly in fluid communication with the water heater.

11. The emergency shower of claim 10 wherein the eyewash assembly includes an eyewash pipe that extends through the third pipe, through the third conduit, through the second pipe, through the second conduit, and through the first pipe.

12. An emergency shower comprising:
a column including a top end, a bottom end, an outer pipe, an intermediate pipe positioned within the outer pipe, an inner pipe positioned within the intermediate pipe, an annular outer conduit defined between the intermediate pipe and the outer pipe, an annular intermediate conduit defined between the inner pipe and the intermediate pipe, and an inner conduit defined within the inner pipe, the inner conduit in fluid communication with the intermediate conduit at one end of the inner pipe, and the intermediate conduit in fluid communication with the outer conduit at an opposing end of the intermediate pipe;
a lower inlet in fluid communication with the outer conduit and physically coupled to the bottom end of the column;
an upper inlet in fluid communication with the outer conduit and physically coupled to the top end of the column;
a heating coil positioned within the intermediate conduit; and
a shower head in fluid communication with the inner conduit such that a flow path exists from the lower inlet, through the outer conduit to the intermediate conduit, through the intermediate conduit to the inner conduit, and through the inner conduit to the shower head.

13. A method of using an emergency shower comprising:
providing a flow of water to an inlet coupled to a column, the inlet in fluid communication with a water heater positioned inside the column and with a shower head coupled to a top end portion of the column; and
causing the water to flow into the emergency shower through the inlet, through the water heater, and out of the emergency shower through the shower head by actuating a lever coupled to the emergency shower.
